(19) United States
(12) Patent Application Publication
(10) Pub. No.: US 2008/0199738 A1
(43) Pub. Date: Aug. 21, 2008

(54) Solid oxide fuel cell interconnect

(75) Inventors: Martin Perry, Sunnyvale, CA (US); Matthias Gottmann, Sunnyvale, CA (US)

Correspondence Address: FOLEY AND LARDNER LLP;SUITE 500, 3000 K STREET NW, WASHINGTON, DC, 20007, US

(73) Assignee: Bloom Energy Corporation

(21) Appl. No.: 11/707,070

(22) Filed: Feb. 16, 2007

(51) Int. Cl. H01M 8/00

(52) U.S. Cl. 429/12; 419/1; 419/28

(57) ABSTRACT

A fuel cell interconnect includes a first surface containing a first plurality of channels and a second surface containing a second plurality of channels. The first and second surfaces are disposed on opposite sides of the interconnect. The first plurality of channels is offset from the second plurality of channels. The thickness of the interconnect measured between the first and second surfaces is substantially constant

### BACKGROUND OF THE INVENTION

The present invention is generally directed to fuel cell components and more specifically to fuel cell stack interconnects.

Fuel cells are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide reversible fuel cells, that also allow reversed operation, such that water or other oxidized fuel can be reduced to unoxidized fuel using electrical energy as an input.

In a high temperature fuel cell system, such as a solid oxide fuel cell (SOFC) system, an oxidizing flow is passed through the cathode side of the fuel cell while a fuel flow is passed through the anode side of the fuel cell. The oxidizing flow is typically air, while the fuel flow is typically a hydrogen-rich gas created by reforming a hydrocarbon fuel source. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit.

Fuel cell stacks may be either internally or externally manifolded for fuel and air. In internally manifolded stacks, the fuel and air is distributed to each cell using risers contained within the stack. In other words, the gas flows through openings or holes in the supporting layer of each fuel cell, such as the electrolyte layer, and gas separator of each cell. In externally manifolded stacks, the stack is open on the fuel and air inlet and outlet sides, and the fuel and air are introduced and collected independently of the stack hardware. For example, the inlet and outlet fuel and air flow in separate channels between the stack and the manifold housing in which the stack is located.

Fuel cell stacks are frequently built from a multiplicity of cells in the form of planar elements, tubes, or other geometries. Fuel and air has to be provided to the electrochemically active surface, which can be large. One component of a fuel cell stack is the so called gas flow separator (referred to as a gas flow separator plate in a planar stack) that separates the individual cells in the stack. The gas flow separator plate separates fuel, such as hydrogen or a hydrocarbon fuel, flowing to the fuel electrode (i.e., anode) of one cell in the stack from oxidant, such as air, flowing to the air electrode (i.e., cathode) of an adjacent cell in the stack. Frequently, the gas flow separator plate is also used as an interconnect which electrically connects the fuel electrode of one cell to the air electrode of the adjacent cell. In this case, the gas flow separator plate which functions as an interconnect is made of or contains an electrically conductive material.

Interconnects are typically fabricated by machining a desired interconnect structure from stock material. The machining process, however, is a serial and expensive fabrication method. It is also difficult to consistently achieve the high tolerance levels required of the interconnect channels by machining.

### SUMMARY OF THE INVENTION

One aspect of the present invention provides a fuel cell interconnect which includes a first surface having a first plurality of channels and a second surface having a second plurality of channels. The thickness of the interconnect measured between the first and second surfaces is substantially constant.

Another aspect of the present invention provides a fuel cell interconnect which includes a first and a second pluralities of channels disposed on opposite sides of the interconnect. The first plurality of channels is offset from the second plurality of channels.

Another aspect of the present invention provides a stack comprising plurality of alternating plate-shaped fuel cells and interconnects. Each major side of each cell is contacted by ribs of two adjacent interconnects. The ribs contacting a given cell are aligned with each other across the cell, and the ribs on opposite sides of each interconnect are offset from each other.

### BRIEF DESCRIPTION OF THE DRAWINGS

FIG. 1A is a side cross-sectional view of a fuel cell interconnect according to the prior art.

FIGS. 1B-1C are side cross-sectional views of a fuel cell interconnect according to embodiments of the present invention.

FIGS. 2A-2C are top views of the interconnect of FIG. 1B according to embodiments of the invention.

FIGS. 3A, 3B, 3C and 3D are side cross-sectional views of fuel cell stacks according to embodiments of the present invention.

### DETAILED DESCRIPTION OF THE PREFERRED EMBODIMENTS

Fuel cell stacks are frequently built from a multiplicity of fuel cells in the form of planar elements, tubes, or other geometries. Fuel and air has to be provided to the electrochemically active surface, which can be large. While solid oxide fuel cells are preferred, other fuel cell types, such as molten carbonate, PEM, phosphoric acid, etc., may also be used instead of SOFCs.

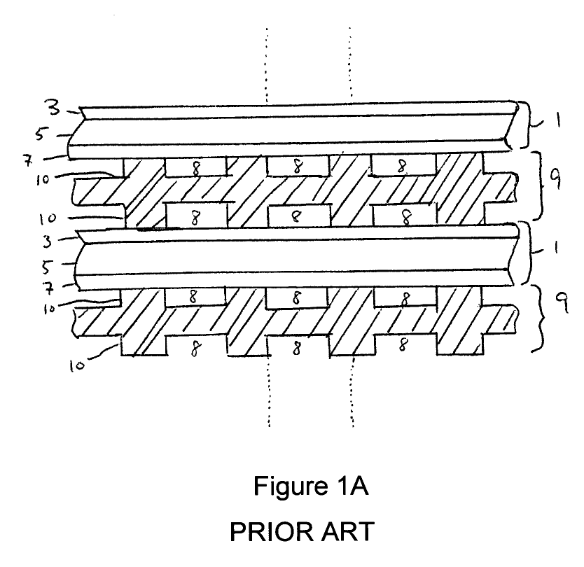

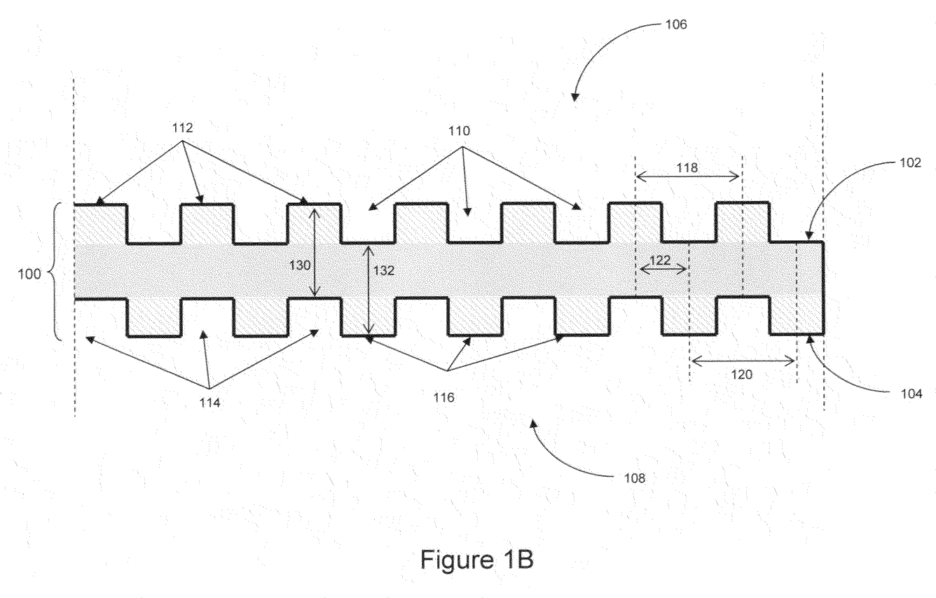

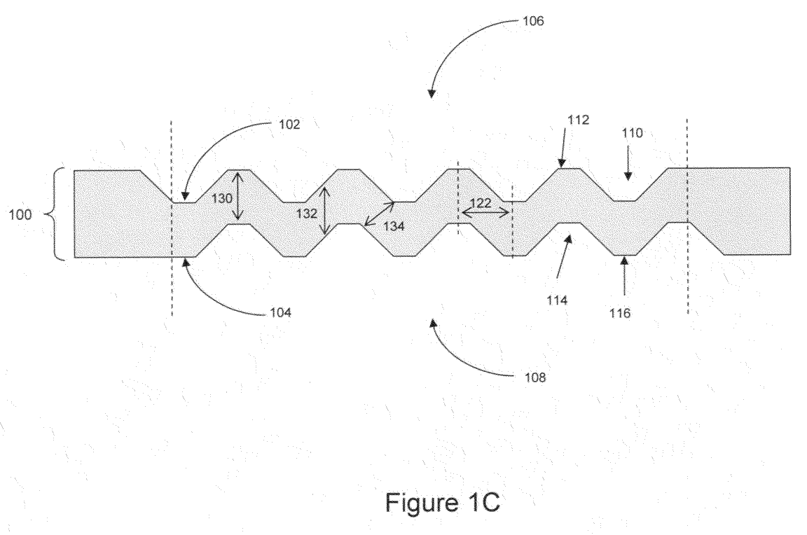

As shown in FIG. 1A, each SOFC 1 includes an anode electrode 3, a solid oxide electrolyte 5 and a cathode electrode 7. The anode electrode 3 may comprise a cermet comprising a nickel containing phase and a ceramic phase. The nickel containing phase preferably consists entirely of nickel in a reduced state. This phase forms nickel oxide when it is in an oxidized state. Thus, the anode electrode is preferably annealed in a reducing atmosphere prior to operation to reduce the nickel oxide to nickel. The nickel containing phase may include other metals in additional to nickel and/or nickel alloys. The ceramic phase may comprise a stabilized zirconia, such as yttria and/or scandia stabilized zirconia and/or a doped ceria, such as gadolinia, yttria and/or samaria doped ceria. The electrolyte 5 may comprise a stabilized zirconia, such as scandia stabilized zirconia (SSZ) or yttria stabilized zirconia (YSZ). Alternatively, the electrolyte 5 may comprise another ionically conductive material, such as a doped ceria. The cathode electrode 7 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 7 may also contain a ceramic phase similar to the anode electrode 3. The electrodes and the electrolyte may each comprise one or more sublayers of one or more of the above described materials.

Another component of a fuel cell stack is the so called gas-flow separator (referred to as a gas flow separator plate in a planar stack) 9 that separates the individual cells in the stack. The gas flow separator plate separates fuel, such as a hydrogen and/or a hydrocarbon fuel, flowing to the fuel electrode (i.e. anode 3) of one cell in the stack, from oxidant, such as air, flowing to the air electrode (i.e. cathode 7) of an adjacent cell in the stack. The separator 9 contains gas flow passages or channels 8 between the ribs 10. The ribs and channels on one side of the separator 9 shown in FIG. 1A are aligned with and not offset from the respective ribs and channels on the other side of the separator 9. Frequently, the gas flow separator plate 9 is also used as an interconnect which electrically connects the fuel electrode 3 of one cell to the air electrode 7 of the adjacent cell. In this case, the gas flow separator plate, which functions as an interconnect, is made of or contains electrically conductive material. The gas flow separator plate (hereinafter “interconnect”) 9 may be formed from a metal alloy, such as a chromium-iron alloy, or from an electrically conductive ceramic material, which optionally has a similar coefficient of thermal expansion to that of the electrolyte 5. An electrically conductive contact layer, such as a nickel contact layer, may be provided between the anode electrode and the interconnect. Another optional electrically conductive contact layer may be provided between the cathode electrode and the interconnect. FIG. 1A shows that the lower SOFC 1 is located between two interconnects 9. While a vertically oriented stack is shown in FIG. 1A, the fuel cells may be stacked horizontally or in any other suitable direction between vertical and horizontal.

The term “fuel cell stack,” as used herein, means a plurality of stacked fuel cells which share a common fuel inlet and exhaust passages or risers. The “fuel cell stack,” as used herein, includes a distinct electrical entity which contains two end plates which are connected to power conditioning equipment and the power (i.e., electricity) output of the stack. Thus, in some configurations, the electrical power output from such a distinct electrical entity may be separately controlled from other stacks. The term “fuel cell stack” as used herein, also includes a part of the distinct electrical entity. For example, plural stacks may share the same end plates. In this case, the stacks jointly comprise a distinct electrical entity.

Interconnects are typically fabricated either from formed sheet metal or via machining from stock material. The machined parts possess a number of valuable features, such as rigidity, relatively low geometric tolerances, excellent heat spreading capability, and high electrical conductivity. Unfortunately, machining is a relatively expensive and unreliable fabrication method. For instance, in a channel with a 1.5 mm hydraulic diameter, tolerances in the vicinity of 10 micrometer can create significant misdistributions of flow. As an alternative to machining, a process of pressing and sintering metal powders can be used to make the interconnects. Powder pressing of interconnects, however, requires modification of a number of features of both the interconnect and stack assembly. For example, in the interconnect 9 of FIG. 1A, the thin interconnect material located between the channels 8 on opposite sides of a given interconnect 9 is susceptible to fracture, especially during the various steps of a powder metallurgy process, such as during the steps of providing a metal powder, such as a Cr—Fe alloy powder containing 4-6 wt % Fe into a die cavity, pressing, repressing, sintering the powder at an elevated temperature during and/or after the step of pressing, and releasing the formed piece from the die. If desired, the formed interconnect piece may be machined to its final shape. Otherwise, the pressed and sintered piece may be used in a fuel cell stack.

FIG. 1B illustrates a portion of a plate shaped interconnect 100 according to a first embodiment of the invention. The interconnect 100 comprises a first surface 102 and a second surface 104 that each cover either a portion or all of a side of the interconnect 100. Each first and second surface 102, 104 contains a first and second plurality of channels 106, 108, respectively. The first plurality of channels 106 contains a first series of channels 110, which are disposed between a first series of ribs 112. Similarly, the second plurality of channels 108 contains a second series of channels 114, which are disposed between a second series of ribs 116. The ribs 112, 116 also provide structural support for the interconnect 100 when the interconnect 100 is being formed by powder pressing or is being used in operation within a SOFC stack. The channels 110, 114 and ribs 112, 116 may be straight, curved, jagged, continuous, or segmented. Although FIG. 1B shows the edges of the channels and ribs as right angles, the edges may be rounded, faceted, or have non-right-angle corners. For example, when viewed in cross section, the first and second series of channels 106, 108 may be triangular with rounded corners. Other cross-sectional shapes, for example elliptical or trapezoidal cross sections, can also be used for the channels.

For powder pressing, it is advantageous that the interconnect 100 have a thickness that is as uniform as possible. Accordingly, the first and second pluralities of channels 106, 108 are offset from each other. For instance, the first and second pluralities of channels 106, 108 are either partially offset from each other (i.e., having some overlap between the two pluralities of channels 106, 108) or completely offset from each other (i.e., having no overlap between the two pluralities of channels 106, 108). FIG. 1B illustrates the case of completely offset pluralities of channels 106, 108. The first series of channels 110 is aligned with the second series of ribs 116, and the first series of ribs 112 is aligned with the second series of channels 114. The thickness of the interconnect 100 measured between the first and second surfaces 102, 104 is substantially constant. For instance, the thickness 130 measured between the first series of ribs 112 and the second series of channels 114 is substantially equal to the thickness 132 measured between the first series of channels 110 and the second series of ribs 116.

The spacing between the peaks of adjacent ribs defines a pitch. For example, the first series of ribs 112 has a first pitch 118, and the second series of ribs 116 has a second pitch 120. Preferably, but not necessarily, the first and second pitches 118, 120 are substantially equal. The pitch is optimized for several considerations. One consideration is the pressure drop in each channel. Preferably, the ribs are spaced sufficiently close together to provide a relatively high pressure drop, which thereby limits and equalizes the flow within the channels. The second consideration is the lateral conductivity of the electrodes. If ribs are spaced too far apart, there may be insufficient electrical contact between the cell electrode and the interconnect, which compromises the performance of the stack. The materials used on the cathode electrode generally have lower conductivity than the anode and therefore dictate the maximum rib spacing.

FIG. 1C illustrates a variation of the first embodiment wherein the first and second pluralities of channels 106, 108 possess trapezoidal cross-sectional shapes rather than rectangular cross-sectional shapes. The channels have a narrower base and a wider opening. The ribs 112, 116 also have a trapezoidal shape, such that the base of each rib is wider than the point of each rib on a respective surface 102, 104. Thus, the interconnect 100 includes a first surface 102 comprising a first plurality of alternating trapezoidal channels 110 and ribs 112, and a second surface 104 comprising a second plurality of alternating trapezoidal channels 114 and ribs 116. Here, the centers of the pluralities of channels 106, 108 are offset by a distance 122 substantially equal to half the pitch. The first and second surfaces 102, 104 cover the portion of the two major sides of the interconnect 100 that both contain pluralities of channels 106, 108 (i.e., between the two longer vertical lines in FIG. 1C). In other words, the first and second surfaces 102, 104 exclude those portions of the interconnect 100 that contain incomplete pluralities of channels 106, 108. The thickness of the interconnect 100 measured between the first and second surfaces 102, 104 (i.e., the vertical distance between the top and bottom surface of the interconnect) is substantially constant. In particular, the thickness of the interconnect 100 measured in the direction of powder pressing between the first and second surfaces 102, 104 is substantially constant (i.e., the thickness 130 is substantially equal to the thickness 132). Additionally, the thickness of the interconnect as measured by the shortest (i.e., diagonal) distance 134 between the surfaces 102, 104 is substantially constant and uniform. In other words, the difference between the vertical thickness 130 or 132 and the shortest distance (i.e., diagonal) thickness 134 is smaller (i.e., the difference is small or non-existent) for trapezoidal channels than for rectangular channels shown in FIG. 1B. This is beneficial for powder flow during powder pressing of the interconnect.

In FIGS. 1B and 1C, the centers of the pluralities of channels 106, 108 are offset by a distance 122 substantially equal to half the pitch. In other embodiments, the pluralities of channels 106, 108 are offset by a distance 122 not equal to an integer multiple of the pitch, such that there is at least a partial overlap between ribs 112 of the first surface 102 and channels 114 of the second surface 104. In the case of offset but partially overlapping pluralities of channels 106, 108, the first series of ribs 112 may overlap both the second series of ribs 116 and the second series of channels 114, thus imparting greater structural stability to the interconnect 100 than if the first and second series of ribs 112, 116 were perfectly aligned.

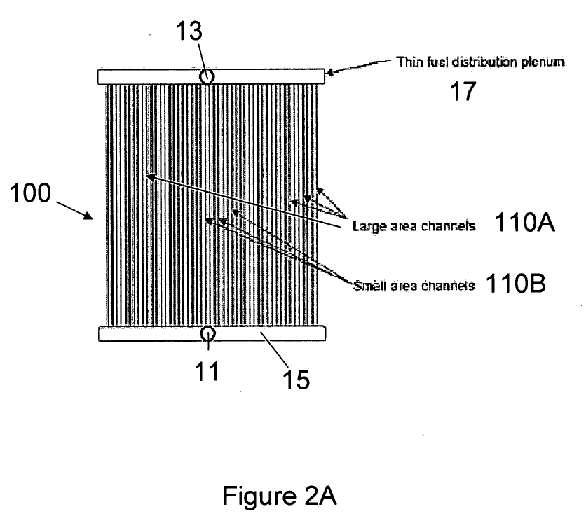

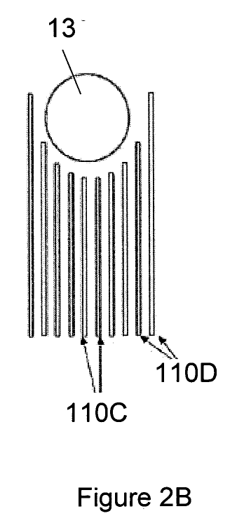

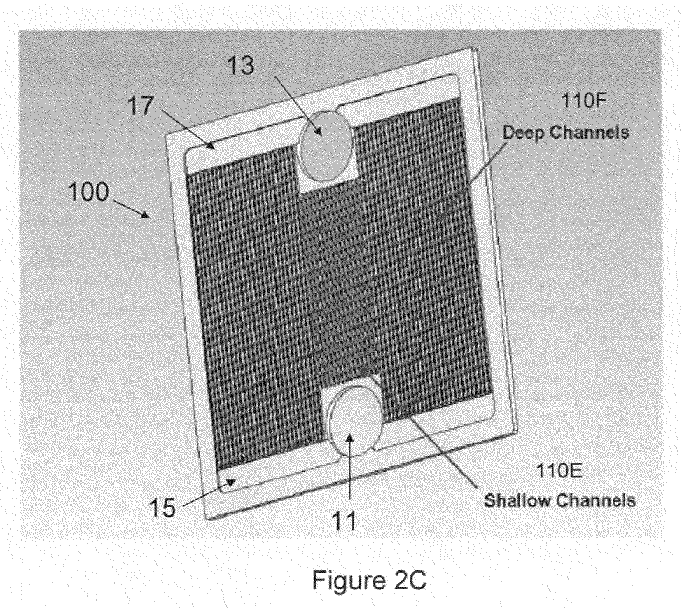

FIG. 2A illustrates an interconnect 100 with fuel distribution plenums 15, 17. Each plenum 15, 17 is a groove in the interconnect which surrounds the respective inlet 11 and outlet 13 opening. The plenum 15 distributes the fuel from the inlet opening 11 to the channels 110 located in the flow field. Plenum 17 collects the fuel or fuel exhaust from the channels and provides it to the outlet opening 13. Generally, there may be several sources of fuel misdistribution, such as different channel length in different portions of the interconnect and/or the finite pressure drop inside the plenums 15, 17. On the side of the interconnect opposite these fuel distribution plenum (i.e., the air side), a seal is provided around the riser hole to avoid mixing of fuel and air within the stack. This seal area can potentially block the air flow to a portion of the air side. Preferably, a horseshoe-shaped channel feeds air around the seal area. The small area between the plenums 15, 17 on one side and the horseshoe shaped air channel on the other side of the interconnect typically forms a relatively thin cross section of solid. Thin cross sections are not easy to press since excessive pressure can build up on the pressing tool, for instance during powder metallurgy. Therefore, the bottom of the fuel distribution plenum is preferably raised in the area of the horseshoe air channel, thereby increasing the cross section of the solid portion of the interconnect. The depth and height of these features can be accommodated so as to provide a thickness of the interconnect that is as uniform as possible. Preferably, the plenums 15, 17 are sized such that the pressure drop in the plenums is negligible when compared to the pressure drop in the parallel channels, thereby assuring uniform flow distribution in all parallel channels. In an alternative embodiment, the distribution plenum 17 is kept smaller and the channels 110 have different cross sections, such that equal flow per active surface area is obtained.

In FIG. 2A, the inlet 11 and outlet 13 are shown as fuel inlet and outlet openings in the interconnect 100. This interconnect is configured for a fuel cell stack which is internally manifolded for fuel, in which the fuel travels through the stack through fuel riser channels which are formed by mated openings through the stacked interconnects and fuel cells. However, if desired, the interconnect 100 may be configured for a stack which is externally manifolded for fuel. In this case, the top and bottom edges of the interconnect 100 shown in FIG. 2A would function as fuel inlet and outlet, respectively, for the fuel which flows externally to the stack. Furthermore, the interconnect 100 shown in FIG. 2A is configured for a stack which is externally manifolded for air. However, additional openings through the interconnect may be formed on the left and right sides of the interconnect for the interconnect to be configured for a stack which is internally manifolded for air.

The cross-sectional area of the channels on a given surface 102, 104 can be constant or can vary across the width and/or length of the surface. FIG. 2A shows a top view of the interconnect 100 of FIG. 1B in which one set of gas flow channels 110A in one portion of the interconnect 100 has a different (i.e., larger) cross sectional area than another set of gas flow channels 110B in a different portion of the interconnect 100. Both sets of gas flow channels 110A and 110B are located on the same side of the interconnect 100, such as the fuel side of the interconnect which faces the anode electrode 3 of the adjacent cell. The channels on the opposite side of the interconnect, for instance on the air side (not show), are offset from the channels 110 on the fuel side. Preferably, but not necessarily, the thickness of the interconnect 100 measured between the first surface 106 on the fuel side and the second surface 108 on the air side is substantially constant. Preferably, but not necessarily, each gas flow channel has the same cross sectional area throughout its length. In other words, the cross sectional area (i.e., width and depth) of each channel does not change in the channel length direction (i.e., in the direction from the fuel inlet to the fuel outlet).

In FIG. 2A, the first set of gas flow channels 110A have a larger width than the second set of gas flow channels 110B. The channels 110A that are subjected to lower pressure drops have a larger width than the channels 110B subjected to a higher pressure drop, such that the gas flow (e.g., fuel flow) through channels 110A is substantially equal to the gas flow through channels 110B. For example, as shown in FIG. 2A, the channels 110B located in the middle region of the interconnect between the gas inlet 11 and the gas outlet 13 openings have smaller width than the channels 110A in peripheral regions of the interconnect which are laterally spaced from the imaginary line between the inlet 11 and the outlet 13. Thus, the gas flow rate, such as fuel flow rate, through all channels 110A, 110B in the interconnect is about equal.

In the configuration of FIG. 2A, all channels 110 have the same length. However, if desired, the channels 110 may have different lengths as shown in FIG. 2B. For example, in FIG. 2B, the middle channels 110C of smaller cross sectional area also have a shorter length than the peripheral channels 110D of larger cross sectional area. For example, channels 110C located between the openings 11, 13 are narrower than the peripheral channels 110D. Thus, the length disparity between channels 110C and 110D and the corresponding difference in pressure drop is compensated by the difference in cross sectional area while maintaining a substantially equal gas flow through all channels. The variable length and width of the channels offers the flexibility to conform the channels around non-rectangular features, such as openings 11, 13 and seals without sacrificing the equal fuel flow through all channels. This may be especially important for taller stacks which require larger diameter openings 11, 13 and large area seals around the openings.

While FIGS. 2A and 2B illustrate channels with different width to obtain a difference in cross sectional area, the depth and/or the shape of the channels may also be varied. Thus, the channels in different portions of the interconnect may have a different width and/or depth and/or shape to obtain a difference in cross sectional area which results in a substantially equal gas flow through all channels. FIG. 2C illustrates an interconnect in which the middle channels 110E are shallower than peripheral channels 110F. Channels 110E may also be shorter than channels 110F. Furthermore, the difference in cross sectional area may be achieved by varying the cross sectional shape of the channels, where the different shapes are selected from triangular, rectangular, semi-circular, semi-oval, etc. shapes.

While the fuel side of the interconnect 100 is shown in FIGS. 2A-C, the channels on the air side of the interconnect may also have a similar difference in cross sectional area. The channels on the air side are offset from the channels on the fuel side. For instance, the channels are either completely or partially offset. Preferably, the ribs on the air side overlap with the channels and ribs on the fuel side. For example, the ribs on the air side overlap only with the channels on the fuel side and not with the ribs on the fuel side. Preferably, but not necessarily, the thickness of the interconnect 100 measured between the first surface 102 on the fuel side and the second surface 104 on the air side is substantially constant (where the surfaces 102, 104 do not include the openings 11, 13 which have zero thickness). Furthermore, while only two sets of channels are shown in FIGS. 2A-2C, the interconnect may have three or more sets of channels with different cross sectional areas from each other. If desired, the cross sectional area of the channels may be graded across the interconnect, such that each channel may have a different cross sectional area from an adjacent channel. For example, the central channels 110E directly between the openings 11, 13 may have the smallest cross sectional area, while the cross sectional area of the channels 110F on either side of the central channel increases with distance from the central channel, such that the edge channels on either side of the interconnect have the largest cross sectional area.

The different channel cross sectional area provides a uniform gas (e.g., fuel and/or air) flow through the channels over (or under) the adjacent fuel cell, while maintaining the maximum electrochemically active area. The uniform gas flow through the interconnects provides a uniform current density and temperature for the fuel cells of the stack, which lead to an improved power output control, lower thermal stresses and lower cell degradation.

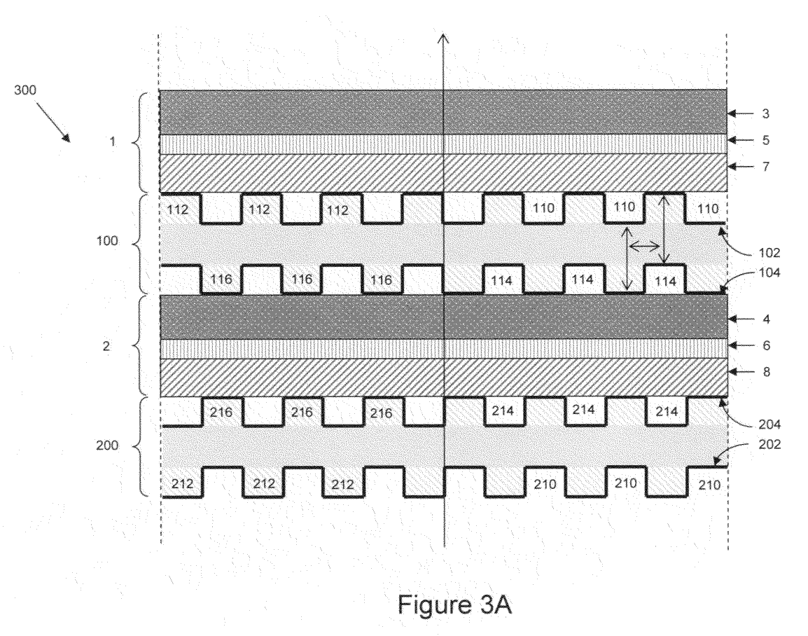

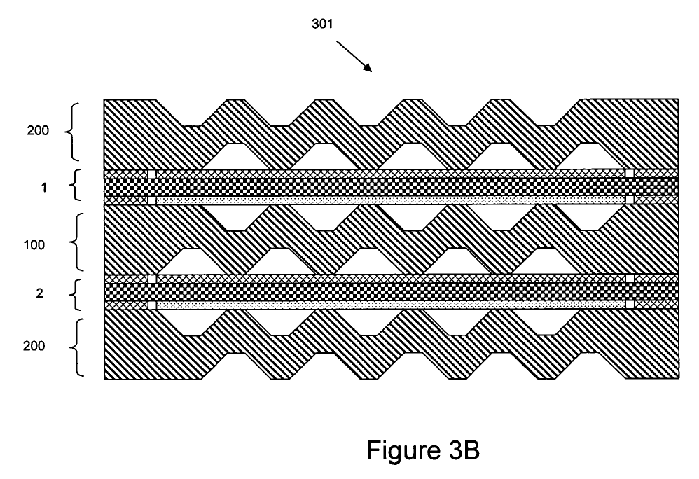

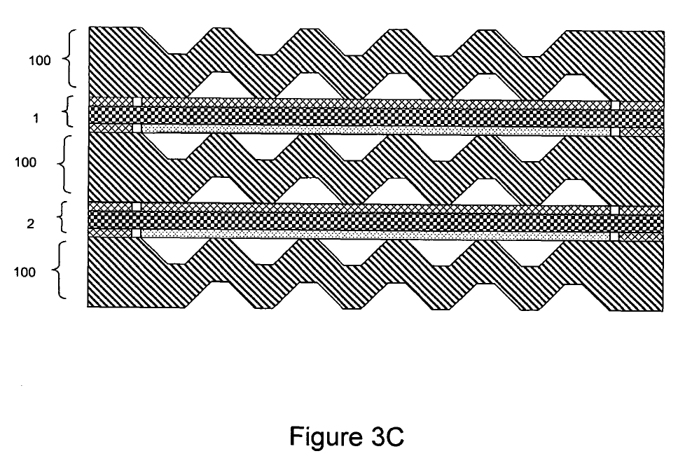

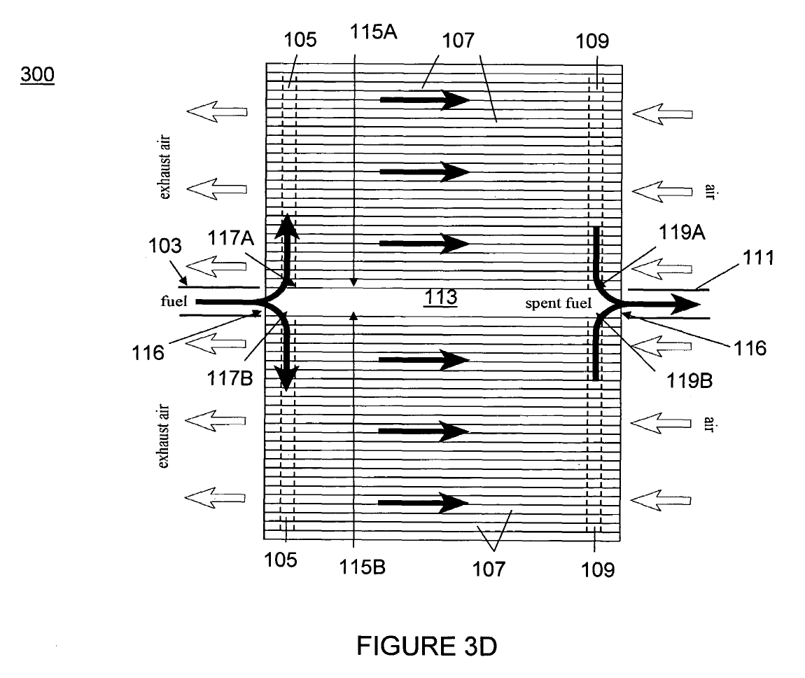

FIG. 3A illustrates a fuel cell stack 300 with alternating plate-shaped fuel cells 1, 2 and interconnects 100, 200. Each major side of each cell 1, 2 is contacted by ribs 112, 116, 212, 216 of two adjacent interconnects 100, 200. For example, the fuel electrode (i.e. anode 4) of the second cell 2 is contacted by the ribs 116 of the second surface 104 of the first interconnect 100. The air electrode (i.e. cathode 8) of the second cell 2 is contacted by the ribs 216 of the second surface 204 of the second interconnect 200. Conceptually, interconnect 200 may be formed by rotating interconnect 100 around an axis perpendicular to the plane of the page by 180 degrees, thereby flipping the fuel side over to the air side and vice versa. Alternatively, interconnect 200 may be formed by rotating interconnect 100 around an axis parallel to the thickness of the interconnect (the axis is shown in FIG. 3A as an arrow) by 180 degrees, thereby keeping the fuel and air sides on their respective sides. The ribs 116, 216 contacting cell 2 are aligned with each other across cell 2, such that the cell experiences primarily compressive forces between interconnect 100 and interconnect 200. The interconnect may also have trapezoidal ribs and channels instead of rectangular ribs and channels shown in FIG. 3A. FIG. 3B illustrates a stack 301 containing interconnects 100, 200 with trapezoidal ribs and channels, similar to those shown in FIG. 1C. On the other hand, if cell 2 were contacted on both sides by the same type of interconnect (e.g., either interconnect 100 or interconnect 200) such that the contacting ribs were misaligned across cell 2, as shown in FIG. 3C, then cell 2 would be subjected to bending and shear forces rather than compressive forces.

The channels 114, 214 are also aligned with each other across cell 2 and provide gas flow to their respective electrodes 4, 8. For instance, channels 114 provide an anode flow, such as a fuel flow, to the anode 4; and channels 214 provide an oxidant flow, such as an air flow, to the cathode 8. The ribs on opposite sides of each interconnect are offset from each other. In interconnect 100, the ribs 112 are offset from the ribs 116; and in interconnect 200, the ribs 212 are offset from the ribs 216. The ribs may be partially offset such that ribs 112 partially overlap both with ribs 116 and with channels 114. Alternatively, the ribs may be completely offset such that ribs 112 do not overlap with ribs 116.

The stack 300 may provide internal and/or external manifolding. For instance, in one design of fuel cell stacks referred to as “internally manifolded for fuel,” the fuel is distributed from layer to layer by a so called riser channel. This is a series of aligned openings in every layer (i.e., openings through each fuel cell and interconnect) which allows fuel to flow from the inlet end of the stack to each and every cell. Specifically, the fuel inlet riser channel is formed by aligned fuel inlet openings in the interconnects and in the fuel cells while the fuel outlet riser channel is formed by aligned fuel outlet openings in the interconnects and in the fuel cells.

These riser channels always impart a finite pressure drop on the fuel flowing through the riser. This implies that layers further away from the inlet receive fuel at lower pressure than those nearer the inlet. In some designs this is partially compensated for by running the exhaust riser parallel to inlet riser (so called “Z-flow” in which the fuel inlet stream and the fuel exhaust stream flow are parallel and concurrent to each other, with the fuel inlet stream crossing the stack at each anode electrode). However, due to the simplicity in manifolding a configuration with opposing flow in the riser channels (so-called “U-flow” in which the fuel inlet stream and the fuel exhaust stream flow in opposite directions) is often used. In this configuration, the inlet and the outlet are at the same end of the stack, such as at the bottom of the stack, or in a manifold located in a middle of a stack.

A stack 300 which is internally manifolded for fuel with U-flow configuration and a fuel manifold is shown in FIG. 3D. The stack contains a fuel inlet riser channel 105 and a fuel outlet riser channel 109. If desired, the stack may contain plural fuel inlet riser channels 105 and/or plural fuel outlet riser channels 109. The stack is externally manifolded for air and contains no air riser channels. In the stack 300, at least one fuel delivery port 103 and at least one fuel outlet port 111 is connected to a fuel manifold 113 located between adjacent plate shaped fuel cells 107, such as SOFCs (the interconnects between the cells are omitted for clarity from this Figure). An example of a plate shaped manifold is described in U.S. application Ser. No. 11/276,717, filed on Mar. 10, 2006, incorporated herein by reference in its entirety. In one example, the stack 300 contains a plurality of fuel delivery ports 103 and a plurality of fuel outlet ports 111. The stack 300 also contains a plurality of fuel manifolds 113, such that each of the plurality of fuel delivery ports 103 is connected to a respective one of a plurality of fuel manifolds 113. The stack 300 comprises a complete and independent electrical entity. In another example, the stack 300 contains only one fuel manifold 113 which is located between adjacent plate shaped fuel cells 107. In other words, the fuel manifold 113 is located between the fuel cells 107 in the stack rather than at the edge of the stack between the last (i.e., edge) fuel cell in the stack and an end plate of the stack.

As shown in FIG. 3D, the fuel manifold 113 introduces fresh fuel from fuel inlet port 103 into the fuel inlet riser channels 105 through fuel delivery openings 117A and 117B. The fuel flows from the fuel inlet riser channels 105 through the fuel cells 107 (i.e., through fuel flow channels between the fuel (anode) electrodes and the gas separator/interconnect plates) and into the fuel outlet riser channels 109. The spent or exhausted fuel (i.e., fuel exhaust) is provided from the fuel outlet riser channels 109 into the fuel outlet openings 119A and 119B of the fuel manifold. The exhausted fuel is then removed from the stack 101 via the fuel outlet port 111. Multiple riser channels 105, 109 may be used. Preferably, but not necessarily, the riser channels 105, 109 are aligned in all layers. In another embodiment, the number of riser channels 105, 109 varies from layer to layer. For instance, more channels are present near the stack end where higher flow rates need to be accommodated. In the vertically positioned stack 300, the fuel flows up and down to and from the manifold 113 through channels 105 and 109. However, if the stack 300 is positioned horizontally, then the fuel would flow in horizontal planes through channels 105, 109.

FIG. 3D also shows the oxidizer (i.e., air) flow in the fuel cell stack 300 that has an external manifolding configuration on the oxidizer side. The oxidizer (i.e., air) is provided from one side of the stack 300, travels through the fuel cells 107 (i.e., between the oxidizer (cathode) electrodes and gas separator/interconnect plates) and exits on the opposite side of the stack 300. In another embodiment, fuel is provided to and removed from the stack at opposing ends of the stack (“Z-flow”). In solid oxide fuel cells, a portion of the oxidizer (i.e., oxygen present in air) is transported through the fuel cell electrolyte in the form of oxygen ions and reacts with the fuel to generate the fuel exhaust, such as water. FIG. 3D shows a flow configuration where fuel and air flow in parallel but opposite directions along the fuel cells 107 (“counter-flow”). However, fuel and air may flow in parallel and same direction (“co-flow”), in perpendicular directions, or in any direction in between. Furthermore, as noted above, the stack 300 may instead have an internal manifolding configuration on the air side. In another embodiment, only the fuel supply is internally manifolded and the fuel exhaust is open, such that exhausted fuel and air will mix outside the stack.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A fuel cell interconnect, comprising:
a first surface comprising a first plurality of channels; and
a second surface comprising a second plurality of channels;
wherein:
a thickness of the interconnect measured between the first and second surfaces is substantially constant.

2. The interconnect of claim 1, wherein:
the first plurality of channels comprises a first series of channels disposed between a first series of ribs;
the second plurality of channels comprises a second series of channels disposed between a second series of ribs; and
the thickness of the interconnect measured between the first series of ribs and the second series of channels is substantially equal to the thickness of the interconnect measured between the first series of channels and the second series of ribs.

3. The interconnect of claim 2, wherein:
the first series of channels is aligned with the second series of ribs; and
the second series of channels is aligned with the first series of ribs.

4. The interconnect of claim 2, wherein:
the first series of ribs comprises a first pitch between adjacent ribs;
the second series of ribs comprises a second pitch between adjacent ribs;
the first pitch is substantially equal to the second pitch; and
the first and second series of ribs are offset from each other by a distance substantially equal to half the first or second pitch.

5. The interconnect of claim 2, wherein:
the first series of channels comprises cathode flow channels;
the second series of channels comprises anode flow channels;
the cathode flow channels comprise air flow channels; and
the anode flow channels comprise fuel flow channels.

6. The interconnect of claim 5, wherein:
the air flow channels are externally manifolded; and
the fuel flow channels are internally manifolded.

7. The interconnect of claim 1, wherein the interconnect is made by a process comprising powder metallurgy.

8. The interconnect of claim 2, wherein the first and the second series of channels comprise trapezoidal channels each having a base which is narrower than an opening, and the first and the second series of ribs comprise trapezoidal ribs each having a base which is wider than a tip.

9. A fuel cell interconnect, comprising:
a first surface comprising a first plurality of channels; and
a second surface comprising a second plurality of channels;
wherein:
the first and second surfaces are disposed on opposite sides of the interconnect; and
the first plurality of channels is offset from the second plurality of channels.

10. The interconnect of claim 9, wherein:
the first plurality of channels is partially offset from the second plurality of channels.

11. The interconnect of claim 10, wherein:
the first plurality of channels comprises a first series of channels disposed between a first series of ribs;
the second plurality of channels comprises a second series of channels disposed between a second series of ribs; and
the first series of ribs is partially offset from the second series of ribs, such that the first series of ribs partially overlaps with both the second series of ribs and the second series of channels.

12. The interconnect of claim 9, wherein:
the first plurality of channels is completely offset from the second plurality of channels.

13. The interconnect of claim 12, wherein:
the first plurality of channels comprises a first series of channels disposed between a first series of ribs;
the second plurality of channels comprises a second series of channels disposed between a second series of ribs;
the first series of ribs is completely offset from the second series of ribs, such that the first series of ribs does not overlap with the second series of ribs;
the first and the second series of channels comprise trapezoidal channels each having a base which is narrower than an opening; and
the first and the second series of ribs comprise trapezoidal ribs each having a base which is wider than a tip.

14. A fuel cell stack, comprising a fuel cell disposed between a first interconnect and a second interconnects; wherein:
the first and the second interconnects each comprise the interconnect of claim 9;
each major side of the cell is contacted by a contacting side of the first and the second interconnect; and
each contacting side of the first and the second interconnect comprises the first surface of the respective first and the second interconnect.

15. The fuel cell stack of claim 14, wherein the first plurality of channels of the first interconnect is aligned with the first plurality of channels of the second interconnect.

16. The fuel cell stack of claim 15, wherein:
the fuel cell comprises an electrolyte layer disposed between a cathode electrode and an anode electrode;
the cathode electrode is contacted by the contacting side of the first interconnect;
the anode electrode is contacted by the contacting side of the second interconnect;
the first series of channels of the first interconnect comprises cathode flow channels; and
the first series of channels of the second interconnect comprises anode flow channels.

17. The fuel cell stack of claim 16, wherein:
the cathode flow channels comprise air flow channels that are externally manifolded; and
the anode flow channels comprise fuel flow channels that are internally manifolded.

18. The fuel cell stack of claim 14, further comprising an end plate on each end of the stack.

19. A fuel cell stack comprising a plurality of alternating plate-shaped fuel cells and interconnects, wherein:
each major side of each cell is contacted by ribs of two adjacent interconnects;
the ribs contacting a given cell are aligned with each other across the cell; and
the ribs on opposite sides of each interconnect are offset from each other.

20. The fuel cell stack of claim 19, wherein the ribs on opposite sides of each interconnect are offset from each other by a distance not equal to a pitch between adjacent ribs.

21. The fuel cell stack of claim 20, wherein the distance is substantially equal to half the pitch.

22. The fuel cell stack of claim 19, wherein:
each fuel cell comprises an electrolyte layer disposed between a cathode electrode and an anode electrode;
the stack is internally manifolded on the anode side of each fuel cell; and
the stack is externally manifolded on the cathode side of each fuel cell.

23. The fuel cell stack of claim 19, wherein:
ribs comprise trapezoidal ribs each having a base which is wider than a tip; and
the ribs are separated from each other by trapezoidal channels each having a base which is narrower than an opening.

24. A method of making a fuel cell interconnect, comprising:
providing a metal powder into a die; and
sintering the metal powder in the die at an elevated temperature to form the interconnect;
wherein:
each major side of the interconnect comprises a series of ribs; and
the ribs on opposite sides of each interconnect are offset from each other.

25. The method of claim 24, further comprising pressing the powder before or during the step of sintering.

26. The method of claim 25, further comprising releasing the interconnect from the die and machining the interconnect after the step of releasing.

27. The method of claim 24, wherein:
the ribs comprise trapezoidal ribs each having a base which is wider than a tip; and
the ribs are separated by trapezoidal channels each having a base which is narrower than an opening.

28. A fuel cell interconnect, comprising:
a first surface comprising a first plurality of alternating trapezoidal channels and ribs; and
a second surface comprising a second plurality of alternating trapezoidal channels and ribs.
